(19) United States
(12) Patent Application Publication
(10) Pub. No.: US 2013/0135185 A1
(43) Pub. Date: May 30, 2013

(54) DRIVER CIRCUIT FOR DISPLAY DEVICE AND DISPLAY DEVICE INCLUDING THE DRIVER CIRCUIT

(71) Applicant: Semiconductor Energy Laboratory Co., Ltd., Atsugi-shi (JP)

(72) Inventors: Shuhei Nagatsuka, Atsugi (JP); Tomoaki Atsumi, Hadano (JP); Jun Koyama, Sagamihara (JP)

(73) Assignee: SEMICONDUCTOR ENERGY LABORATORY CO., LTD., Atsugi-shi (JP)

(21) Appl. No.: 13/688,789

(22) Filed: Nov. 29, 2012

(30) Foreign Application Priority Data
Nov. 30, 2011 (JP) 2011-262571

(51) Int. Cl. G09G 3/36

(52) U.S. Cl. CPC G09G 3/36
USPC 345/87

(57) ABSTRACT

A display device driver circuit in which a lookup table can be written into a memory circuit within a retrace period even when the lookup table is constantly reconstructed in accordance with a change in the external environment and stored in the memory circuit, and data of the lookup table can be held even if supply of power supply voltage stops. In a driver circuit for a display device, a memory circuit including a transistor having a semiconductor layer containing an oxide semiconductor is used as a memory circuit that stores a lookup table for correcting image signals in accordance with a change in the external environment.

### BACKGROUND OF THE INVENTION

1. Field of the Invention

The present invention relates to a driver circuit for a display device (hereinafter also referred to as display device driver circuit). The present invention also relates to a display device including the driver circuit.

2. Description of the Related Art

Commoditization of display devices such as liquid crystal televisions has progressed as a result of recent technological innovation. Higher value-added products are being required and have still been actively developed.

An example of the added value required for a display device is high image quality of a display device. For example, Patent Document 1 discloses a structure in which correction of inputted image signals is dynamically controlled in order to achieve higher image quality of a display device.

### REFERENCE

Patent Document 1: Japanese Published Patent Application No. 2006-113311

### SUMMARY OF THE INVENTION

By dynamically controlling correction of inputted image signals, the image signals can be corrected in accordance with the change in the external environment, so that a display device can have higher image quality. In order to dynamically control correction of inputted image signals, a lookup table for converting image signals is required to be generated in accordance with the change in the external environment and stored in a memory circuit. Accordingly, image signals can be subjected to correction corresponding to a change in the external environment while referring to the lookup table which has been stored in the memory circuit in advance.

A memory element in the memory circuit which stores the lookup table for converting image signals is preferably a nonvolatile memory, which can maintain stored data even if supply of power supply voltage stops. With the use of a nonvolatile memory, the contents of the lookup table stored in the memory circuit can be maintained even if supply of the power supply voltage stops, so that power consumption can be reduced. In addition, even when the lookup table is not updated, for example, when images are displayed in the same environment for a long time, the contents of the lookup table stored in the memory circuit can be maintained without supply of the power supply voltage; consequently, power consumption can be reduced.

On the other hand, when the external environment is constantly changed and the lookup table is generated and stored in the memory circuit each time the external environment is changed, the lookup table is required to be generated and stored in the memory circuit while images are displayed. In this case, the lookup table needs to be generated and stored in the memory circuit in a period (e.g., a retrace period) different from a period during which image signals are corrected while referring the lookup table. This is because if the lookup table is updated while images are displayed, image signals are not normally corrected, which causes display defects.

Unfortunately, since a nonvolatile memory such as a Flash EEPROM (flash memory) takes several milliseconds to rewrite data, there is not enough time to generate a lookup table and store it in a memory circuit in a retrace period of a high-definition display device. Moreover, a flash memory requires high voltage for rewriting data, which creates a problem of increase in circuit size due to addition of a circuit such as a step-up circuit.

In view of the above, an object of one embodiment of the present invention is to provide a driver circuit that is used in a display device and includes a memory circuit. In the driver circuit, a lookup table can be written into the memory circuit within a retrace period even when the lookup table is constantly reconstructed in accordance with a change in the external environment and stored in the memory circuit, and data of the lookup table can be held even if supply of power supply voltage stops.

According to one embodiment of the present invention, a transistor including an oxide semiconductor in a channel formation region is used as a memory element in a memory circuit that is provided in a driver circuit of a display device and stores a lookup table for correcting image signals in accordance with a change in the external environment. The memory circuit includes a first transistor, a second transistor, and a capacitor. A gate electrode of the first transistor is connected to one electrode of the second transistor. A channel formation region of the second transistor contains an oxide semiconductor. One electrode of the capacitor is provided over the one electrode of the second transistor.

One embodiment of the present invention is a display device driver circuit including a memory circuit configured to store a lookup table for correcting an image signal. A memory element provided in the memory circuit includes a first transistor, a second transistor, and a capacitor. A gate electrode of the first transistor is connected to one electrode of the second transistor. A semiconductor layer of the second transistor contains an oxide semiconductor. One electrode of the capacitor is provided over the one electrode of the second transistor.

Another embodiment of the present invention is a display device driver circuit including a memory circuit configured to store a lookup table for correcting an image signal. A memory element provided in the memory circuit includes a first transistor, a second transistor, and a capacitor. The first transistor includes a first semiconductor layer, a first gate insulating layer provided over the first semiconductor layer, a first gate electrode provided over the first gate insulating layer to overlap part of the first semiconductor layer, one electrode in contact with the first semiconductor layer, and an other electrode in contact with the first semiconductor layer. The second transistor includes a second semiconductor layer, one electrode in contact with the second semiconductor layer, an other electrode in contact with the second semiconductor layer, a second gate insulating layer provided over the second semiconductor layer, and a second gate electrode provided over the second gate insulating layer to overlap part of the second semiconductor layer. The capacitor includes the one electrode of the second transistor, the second gate insulating layer, and a capacitor electrode provided over the second gate insulating layer. The second semiconductor layer contains an oxide semiconductor. The first gate electrode and the one electrode of the second transistor are directly connected to each other.

Another embodiment of the present invention is a display device driver circuit including a memory circuit, a memory control circuit, and an image signal output circuit. The memory circuit is configured to store a lookup table that is used for correcting an image signal and is generated in a display control circuit based on a signal from a sensor circuit detecting a change in external environment. The memory control circuit is configured to write the lookup table, generated in the display control circuit, into the memory circuit. The image signal output circuit is configured to output, to a display panel, the image signal corrected in accordance with the lookup table. A memory element provided in the memory circuit includes a first transistor, a second transistor, and a capacitor. A gate electrode of the first transistor is connected to one electrode of the second transistor. A semiconductor layer of the second transistor contains an oxide semiconductor. One electrode of the capacitor is provided over the one electrode of the second transistor.

Another embodiment of the present invention is a display device driver circuit including a memory circuit, a memory control circuit, and an image signal output circuit. The memory circuit is configured to store a lookup table that is used for correcting an image signal and is generated in a display control circuit based on a signal from a sensor circuit detecting a change in external environment. The memory control circuit is configured to write the lookup table, generated in the display control circuit, into the memory circuit. The image signal output circuit is configured to output, to a display panel, the image signal corrected in accordance with the lookup table. A memory element provided in the memory circuit includes a first transistor, a second transistor, and a capacitor. The first transistor includes a first semiconductor layer, a first gate insulating layer provided over the first semiconductor layer, a first gate electrode provided over the first gate insulating layer to overlap part of the first semiconductor layer, one electrode in contact with the first semiconductor layer, and an other electrode in contact with the first semiconductor layer. The second transistor includes a second semiconductor layer, one electrode in contact with the second semiconductor layer, an other electrode in contact with the second semiconductor layer, a second gate insulating layer provided over the second semiconductor layer, and a second gate electrode provided over the second gate insulating layer to overlap part of the second semiconductor layer. The capacitor includes the one electrode of the second transistor, the second gate insulating layer, and a capacitor electrode provided over the second gate insulating layer. The second semiconductor layer contains an oxide semiconductor. The first gate electrode and the one electrode of the second transistor are directly connected to each other.

In one embodiment of the present invention, the sensor circuit is preferably a photosensor circuit, a temperature sensor circuit, an angle sensor circuit, and/or a timer circuit.

In one embodiment of the present invention, the first semiconductor layer preferably contains single crystal silicon.

According to one embodiment of the present invention, it is possible to provide a display device driver circuit which includes a memory circuit and in which a lookup table can be written into the memory circuit within a retrace period even when the lookup table is constantly reconstructed in accordance with a change in the external environment and stored in the memory circuit, and data of the lookup table can be held even if supply of power supply voltage stops.

### BRIEF DESCRIPTION OF THE DRAWINGS

In the accompanying drawings:

FIGS. 1A and 1B illustrate Embodiment 1;

FIG. 2 illustrates Embodiment 1;

FIG. 3 illustrates Embodiment 1;

FIG. 4 illustrates Embodiment 1;

FIG. 5 illustrates Embodiment 1;

FIG. 6 illustrates Embodiment 1;

FIG. 7 illustrates Embodiment 1;

FIG. 8 illustrates Embodiment 1;

FIGS. 9A and 9B illustrate Embodiment 1;

FIG. 10 illustrates Embodiment 1;

FIGS. 11A and 11B illustrate Embodiment 2;

FIGS. 12A to 12D illustrate Embodiment 2;

FIGS. 13A to 13D illustrate Embodiment 2;

FIGS. 14A to 14D illustrate Embodiment 2;

FIGS. 15A and 15B illustrate Embodiment 2; and

FIGS. 16A to 16F illustrate Embodiment 3.

### DETAILED DESCRIPTION OF THE INVENTION

Embodiments of the present invention will be described below with reference to the accompanying drawings. Note that the present invention can be carried out in many different modes, and it is easily understood by those skilled in the art that modes and details can be modified in various ways without departing from the spirit and scope of the present invention. Therefore, the present invention is not interpreted as being limited to the description of the embodiments below. Note that in the structures of the present invention described below, reference numerals denoting the same portions are used in common in different drawings.

Note that the size, the thickness of a layer, signal waveform, and a region in structures illustrated in the drawings and the like in the embodiments are exaggerated for simplicity in some cases. Therefore, embodiments of the present invention are not limited to such scales.

Note that in this specification, the terms “first”, “second, “third” to “n-the” (n is a natural number) are used in order to avoid confusion between components and thus do not limit the number of the components.

It is difficult to define a source and a drain of a transistor because of its structure. Accordingly, an electrode that is in contact with a semiconductor layer and serves as one of a source electrode and a drain electrode is hereinafter referred to as “one electrode” of a transistor, and an electrode that is in contact with the semiconductor layer and serves as the other of the source electrode and the drain electrode is hereinafter referred to as “the other electrode” of the transistor.

### Embodiment 1

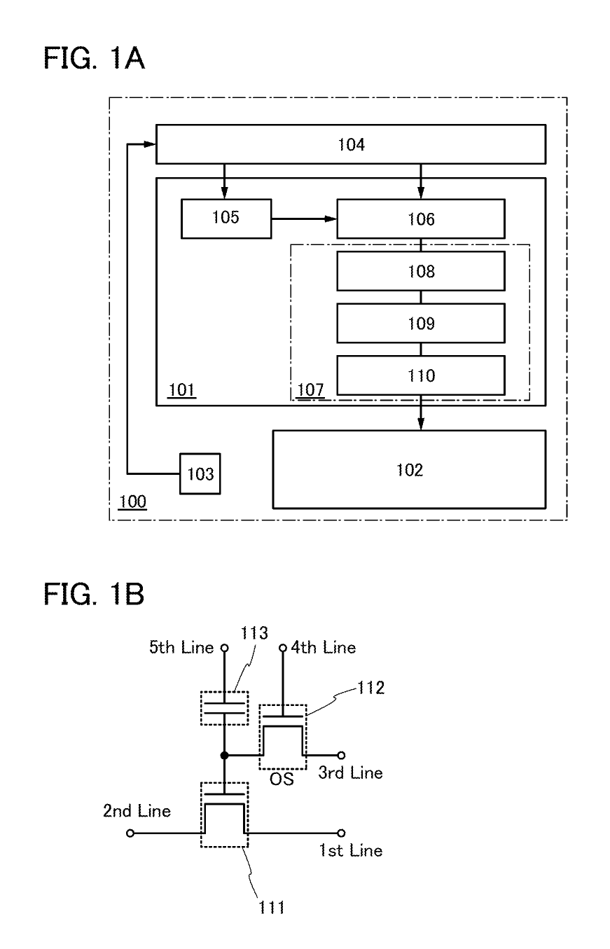

FIG. 1A is a block diagram of a display device including a display device driver circuit. A display device 100 illustrated in FIG. 1A includes a driver circuit 101, a display panel 102, a sensor circuit 103, and a display control circuit 104. The driver circuit 101 includes a memory control circuit 105, a memory circuit 106, and an image signal output circuit 107. The image signal output circuit 107 includes a first latch circuit 108, a second latch circuit 109, and a digital-to-analog converter circuit (D/A converter circuit) 110.

The display panel 102 displays images corresponding to input of image signals. The display panel 102 has a plurality of pixels each including a display element. As the display element, a liquid crystal element or an electroluminescent (EL) element can be used. The display panel 102 is a liquid crystal display panel when the display element is a liquid crystal element, whereas the display panel 102 is an EL display panel when the display element is an EL element.

The sensor circuit 103 detects a change in the external environment. As the sensor circuit 103, a photosensor circuit that detects the illuminance of external light can be used, for example. In a liquid crystal display device, the sensor circuit 103 may serve both as a sensor detecting the illuminance of external light and as a sensor detecting the luminance of a backlight. Further, as the sensor circuit 103, a temperature sensor circuit, an angle sensor circuit, a timer circuit, or the like as well as the photosensor circuit can be used alone or in combination.

The display control circuit 104 generates a lookup table used for dynamically controlling correction of inputted image signals. Here, dynamic control means updating a lookup table in accordance with a change in the external environment. In addition, the display control circuit 104 converts an image signal supplied from the outside into a format suitable for correction and outputs the resulting image signal to the memory circuit 106.

The display control circuit 104 can generate a lookup table corresponding to a change in the external environment, for example, by performing an operation using a formula that converts input and output characteristics including a gamma value. For example, when an m-bit image signal is converted into an n-bit image signal, the relation between the inputted image signal and the outputted image signal can be expressed by Formula 1.

$$OUT = {( \frac{IN}{{2}^{m} - 1} )}^{\frac{1}{γ}} \times ( {2}^{n} - 1 - α ) + β \qquad ( 1 )$$

In Formula 1, OUT is a gray level of the outputted image signal, IN is a gray level of the inputted image signal, γ is a gamma value, m is the number of bits of the inputted image signal, n is the number of bits of the outputted image signal, and α and β (α≧β) are variables for adjusting the gray level of the outputted image signal.

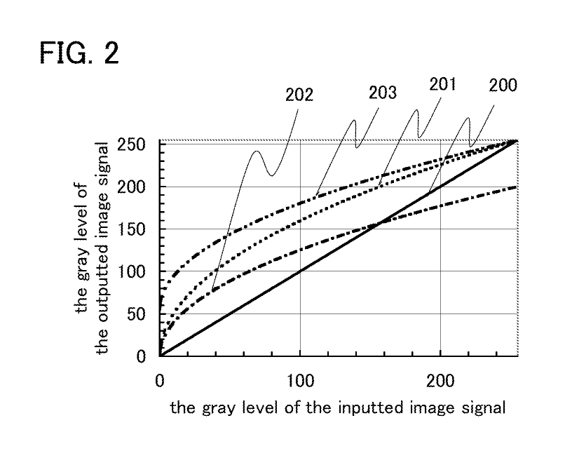

A specific example of generating a lookup table corresponding to a change in the external environment will be described using Formula 1. Here, the case where the illuminance of external light incident on the display panel corresponds to the external environment is considered. FIG. 2 shows plots of the gray level of the inputted image signal versus the gray level of the outputted image signal in different external environments; the plots are obtained by using Formula 1 assuming that the inputted image signal is an 8-bit signal and the outputted image signal is an 8-bit signal.

FIG. 2 shows a straight line 200 representing the relation between the inputted and outputted image signals before conversion; a dotted curve 201 representing the relation when γ is 2.0, α is 0, and β is 0; a one-dot chain curve 202 representing the relation when γ is 2.0, α is 55, and β is 0; and a two-dot chain curve 203 representing the relation when γ is 2.0, α is 55, and β is 55.

When the illuminance is low (i.e., in a dark external environment), a lookup table with which conversion of image signals is performed as shown by the one-dot chain curve 202 is generated. In an image displayed by correcting image signals by using the thus generated lookup table, an image signal whose gray level is too high for a dark environment is converted into an image signal with lower gray level; consequently, the visibility can be increased.

When the illuminance is high (i.e., in a bright external environment), a lookup table with which conversion of image signals is performed as shown by the two-dot chain curve 203 is generated. In an image displayed by correcting image signals by using the thus generated lookup table, an image signal whose gray level is low for a bright environment is converted into an image signal with higher gray level; consequently, the visibility can be increased.

Specifically, when the illuminance of external light either increases or decreases, the display control circuit 104 can output a lookup table by performing an operation so that the gamma characteristics are changed to increase the visibility in accordance with the illuminance change.

The memory control circuit 105 outputs, to the memory circuit 106, data of the lookup table generated in the display control circuit 104 in addition to a signal necessary for writing into the memory circuit 106. Specifically, the memory control circuit 105 generates an address or the like for storing or erasing data of the lookup table and outputs it to the memory circuit 106.

The memory circuit 106 stores data of the lookup table through the memory control circuit 105. Moreover, the memory circuit 106 corrects an image signal output from the display control circuit 104, in accordance with the stored lookup table.

FIG. 1B illustrates the configuration of a memory element included in the memory circuit 106. The memory element is composed of a first transistor 111, a second transistor 112 including an oxide semiconductor, and a capacitor 113. Note that a semiconductor layer of the second transistor 112 contains an oxide semiconductor. In FIG. 1B, “OS” is written beside the second transistor 112 in order to indicate that the second transistor 112 is formed using an oxide semiconductor.

Here, an oxide semiconductor used for the semiconductor layer of the second transistor 112 will be described in detail.

At least indium (In) or zinc (Zn) is preferably contained as an oxide semiconductor used for a channel formation region in the semiconductor layer of the transistor. In particular, In and Zn are preferably contained. A stabilizer for strongly bonding oxygen is preferably contained in addition to In and Zn. As a stabilizer, at least one of gallium (Ga), tin (Sn), zirconium (Zr), hafnium (Hf), and aluminum (Al) may be contained.

As another stabilizer, one or plural kinds of lanthanoid such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu) may be contained.

As the oxide semiconductor, the following can be used, for example: In—Sn—Ga—Zn-based oxide, In—Ga—Zn-based oxide, In—Sn—Zn-based oxide, In—Zr—Zn-based oxide, In—Al—Zn-based oxide, Sn—Ga—Zn-based oxide, Al—Ga—Zn-based oxide, Sn—Al—Zn-based oxide, In—Hf—Zn-based oxide, In—La—Zn-based oxide, In—Ce—Zn-based oxide, In—Pr—Zn-based oxide, In—Nd—Zn-based oxide, In—Sm—Zn-based oxide, In—Eu—Zn-based oxide, In—Gd—Zn-based oxide, In—Tb—Zn-based oxide, In—Dy—Zn-based oxide, In—Ho—Zn-based oxide, In—Er—Zn-based oxide, In—Tm—Zn-based oxide, In—Yb—Zn-based oxide, In—Lu—Zn-based oxide, In—Zn-based oxide, Sn—Zn-based oxide, Al—Zn-based oxide, Zn—Mg-based oxide, Sn—Mg-based oxide, In—Mg-based oxide, In—Ga-based oxide, In-based oxide, Sn-based oxide, and Zn-based oxide.

Note that here, for example, an In—Ga—Zn-based oxide refers to an oxide mainly containing In, Ga, and Zn, and there is no limitation on the ratio of In to Ga and Zn.

A material represented by InMO₃(ZnO)ₘ (m>0) may be used as the oxide semiconductor. Note that M represents one or more metal elements selected from Ga, Fe, Mn, and Co. Alternatively, a material represented by In₂SnO₅(ZnO)ₙ (n>0) may be used as the oxide semiconductor.

For example, an In—Ga—Zn-based oxide with an atomic ratio of In:Ga:Zn=3:1:2, 1:1:1, or 2:2:1, or an oxide with an atomic ratio close to the above atomic ratios can be used. Alternatively, an In—Sn—Zn-based oxide with an atomic ratio of In:Sn:Zn=1:1:1, 2:1:3, or 2:1:5, or an oxide with an atomic ratio close to the above atomic ratios may be used.

Note that for example, the expression “the composition of an oxide with an atomic ratio of In:Ga:Zn=a:b:c (a+b+c=1) is close to the composition of an oxide with an atomic ratio of In:Ga:Zn=A:B:C (A+B+C=1)” means that a, b, and c satisfy Formula 2.

(a−A)²+(b−B)²+(c−C)²≦r² (2)

For example, r may be 0.05. The same applies to other oxides.

However, the composition of the oxide semiconductor is not limited to those described above, and an oxide semiconductor having an appropriate composition may be used depending on necessary semiconductor characteristics (e.g., field-effect mobility or threshold voltage). In order to obtain the required semiconductor characteristics, it is preferable that the carrier concentration, the impurity concentration, the defect density, the atomic ratio between a metal element and oxygen, the interatomic distance, the density, and the like be set to appropriate values.

When an oxide semiconductor is highly purified, the off-state current of a transistor using such an oxide semiconductor for a channel formation region in a semiconductor layer can be sufficiently reduced (here, the off-state current means a drain current when a potential difference between a source and a gate is equal to or lower than the threshold voltage in the off state, for example). A highly purified oxide semiconductor can be obtained, for example, in such a manner that a film is deposited while heating is performed so as to prevent hydrogen and a hydroxyl group from being contained in the oxide semiconductor, or heat treatment is performed after film deposition so as to remove hydrogen and a hydroxyl group from the film. In the case where a highly purified In—Ga—Zn-based oxide is used for a channel formation region of a transistor having a channel length of 10 μm, a semiconductor film thickness of 30 nm, and a drain voltage of about 1 V to 10 V, the off-state current of the transistor can be 1×10⁻¹³ A or less. In addition, the off-state current per channel width (the value obtained by dividing the off-state current by the channel width of the transistor) can be about 1×10⁻²³ A/μm (10 yA/μm) to 1×10⁻²² A/μm (100 yA/μm).

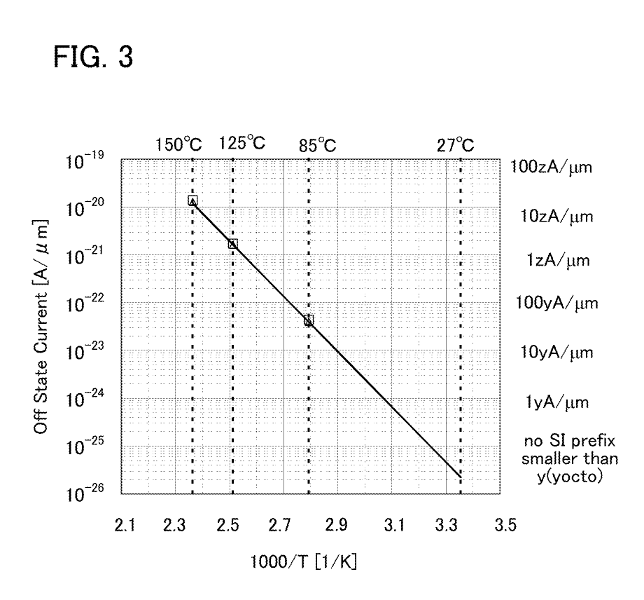

In order to detect extremely low off-state current due to the use of a highly purified oxide semiconductor, a relatively large transistor is fabricated to measure the off-state current, whereby an off-state current that actually flows can be estimated. FIG. 3 shows an Arrhenius plot of the off-state current per channel width W of 1 μm of a large transistor having a channel width W of 1 m (1000000 μm) and a channel length L of 3 μm when the temperature changes to 150° C., 125° C., 85° C., and 27° C. As seen from FIG. 3, the off-state current is extremely low and is estimated as low as 3×10⁻²⁶ A/μm at a temperature of 27° C. The reason the off-state current is measured at elevated temperature is that a very low current at room temperature cannot be measured.

The deposited oxide semiconductor film is in a single crystal state, a polycrystalline (also referred to as polycrystal) state, an amorphous state, or the like.

The oxide semiconductor film is preferably a c-axis aligned crystalline oxide semiconductor (CAAC-OS) film.

The CAAC-OS film is not completely single crystal nor completely amorphous. The CAAC-OS film is an oxide semiconductor film with a crystal-amorphous mixed phase structure where crystal parts and amorphous parts are included in an amorphous phase. Note that in most cases, the crystal part fits inside a cube whose one side is less than 100 nm. From an observation image obtained with a transmission electron microscope (TEM), a boundary between an amorphous part and a crystal part in the CAAC-OS film is not clear. Further, with the TEM, a grain boundary in the CAAC-OS film is not found. Thus, in the CAAC-OS film, a reduction in electron mobility due to the grain boundary is suppressed.

In each of the crystal parts included in the CAAC-OS film, the c-axis is aligned in a direction parallel to a normal vector of a surface where the CAAC-OS film is formed or a normal vector of a surface of the CAAC-OS film, triangular or hexagonal atomic arrangement is formed when seen from the direction perpendicular to the a-b plane, and metal atoms are arranged in a layered manner or metal atoms and oxygen atoms are arranged in a layered manner when seen from the direction perpendicular to the c-axis. Note that among crystal parts, the directions of the a-axis and the b-axis of one crystal part may be different from those of another crystal part. In this specification, the term “perpendicular” includes a range from 85° to 95°. In addition, the term “parallel” includes a range from −5° to 5°.

In the CAAC-OS film, distribution of crystal parts is not necessarily uniform. For example, in the formation process of the CAAC-OS film, in the case where crystal growth occurs from a surface side of the oxide semiconductor film, the proportion of crystal parts in the vicinity of the surface of the oxide semiconductor film is sometimes higher than that in the vicinity of the surface where the oxide semiconductor film is formed. Further, when an impurity is added to the CAAC-OS film, the crystal part in a region to which the impurity is added becomes amorphous in some cases.

Since the c-axes of the crystal parts included in the CAAC-OS film are aligned in the direction parallel to a normal vector of a surface where the CAAC-OS film is formed or a normal vector of a surface of the CAAC-OS film, the directions of the c-axes may vary depending on the shape of the CAAC-OS film (the cross-sectional shape of the surface where the CAAC-OS film is formed or the cross-sectional shape of the surface of the CAAC-OS film). Note that the direction of c-axis of the crystal part is the direction parallel to a normal vector of the surface where the CAAC-OS film is formed or a normal vector of a surface of the CAAC-OS film. The crystal part is formed by film formation or by performing treatment for crystallization such as heat treatment after film formation.

With the use of the CAAC-OS film in a transistor, change in electric characteristics of the transistor due to irradiation with visible light or ultraviolet light is small.

The above is the description of the oxide semiconductor used for the semiconductor layer of the second transistor 112.

In FIG. 1B, a first wiring (1st line) and one electrode of the first transistor 111 are connected to each other. A second wiring (2nd line) and the other electrode of the first transistor 111 are connected to each other. A third wiring (3rd line) and one electrode of the second transistor 112 are connected to each other. A fourth wiring (4th line) and a gate electrode of the second transistor 112 are connected to each other. A gate electrode of the first transistor 111 and the one electrode of the second transistor 112 are directly connected to each other to form one electrode of the capacitor 113. A fifth wiring (5th line) and the other electrode of the capacitor 113 are connected to each other.

In the memory element illustrated in FIG. 1B, data can be written, held, and read as follows by utilizing a feature in that the potential of the gate electrode of the first transistor 111 can be held.

Writing and holding of data will be described. First, the potential of the fourth wiring is set to a potential at which the second transistor 112 is turned on, so that the second transistor 112 is turned on. Thus, the potential of the third wiring is supplied to the gate electrode of the first transistor 111 and the one electrode of the capacitor 113. That is, predetermined charge is applied to the gate electrode of the first transistor 111 (writing). Note that the potential of the fourth wiring in data writing is preferably the same as that in data reading.

Note that here, one of charges providing two different potential levels (hereinafter referred to as data‘1’ charge and data‘0’ charge) is applied. After that, the potential of the fourth wiring is set to a potential at which the second transistor 112 is turned off. The second transistor 112 is turned off, whereby the charge applied to the gate electrode of the first transistor 111 is held (holding).

The off-state current of the second transistor 112 is extremely low because the second transistor 112 includes a highly purified semiconductor layer, so that the charge of the gate electrode of the first transistor 111 is held for a long time.

Then, reading of data will be described. By supplying an appropriate potential (reading potential) to the fifth wiring while a predetermined potential (constant potential) is supplied to the first wiring, the potential of the second wiring varies depending on the amount of charge held in the gate electrode of the first transistor 111. This is because in general, when the first transistor 111 is an n-channel transistor, an apparent threshold voltage Vₜₕ_{_{—}}_{H} when data‘0’ charge is given to the gate electrode of the first transistor 111 is lower than an apparent threshold voltage Vₜₕ_{_{—}}_{L} when data‘0’ charge is given to the gate electrode of the first transistor 111. Here, the apparent threshold voltage refers to the potential of the fifth wiring needed to turn on the first transistor 111. Thus, the potential of the fifth wiring is set to a potential V₀ that is between Vₜₕ_{_{—}}_{H} and Vₜₕ_{_{—}}_{L}, whereby charge supplied to the gate electrode of the first transistor 111 can be determined. For example, in the case where data‘1’ charge is given in writing, the first transistor 111 is turned on when the potential of the fifth wiring is V₀ (>Vₜₕ_{_{—}}_{H}). In the case where data‘0’ charge is applied in writing, the first transistor 111 remains off even when the potential of the fifth wiring is V₀ (<Vₜₕ_{_{—}}_{L}). Accordingly, the data held can be read by measuring the potential of the second wiring.

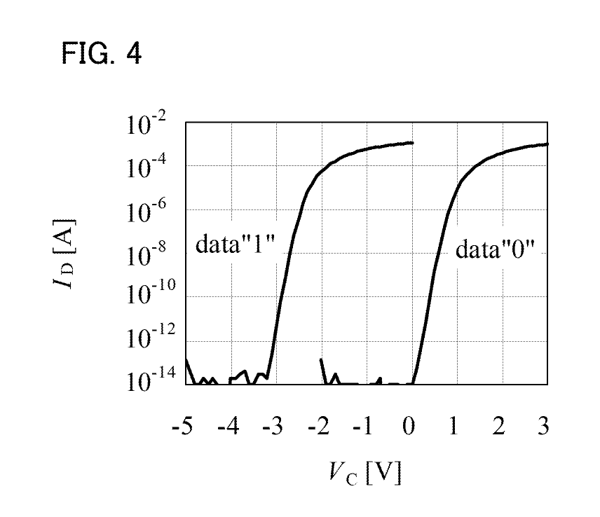

FIG. 4 is a graph showing potential Vc of the fifth wiring (on the horizontal axis) versus drain current Id of the first transistor 111 (on the vertical axis) when data‘0’ charge and data‘1’ charge are given to the gate electrode of the first transistor 111. As shown in FIG. 4, the charge held in the gate electrode of the first transistor 111 can be detected using the amount of Id when the potential Vc of the fifth wiring is approximately −1.5 V.

When the memory elements illustrated in FIG. 1B are arranged in an array, it is necessary to read data only of an intended memory element. In memory elements from which data is not read, the fifth wiring is supplied with a potential at which the first transistor 111 is turned off regardless of the state of the gate electrode of the first transistor 111, that is, a potential lower than Vₜₕ_{_{—}}_{H}. Alternatively, the fifth wiring is supplied with a potential at which the first transistor 111 is turned on regardless of the state of the gate electrode, that is, a potential higher than Vₜₕ_{_{—}}_{L}.

The memory element illustrated in FIG. 1B includes the transistor that uses an oxide semiconductor for a channel formation region and thus has an extremely low off-state current, whereby data can be held for an extremely long time.

In addition, the memory element illustrated in FIG. 1B does not need high voltage for writing data and has no problem of deterioration of the element. For example, unlike a conventional non-volatile memory, it is not necessary to inject and extract electrons into and from a floating gate, and thus a problem such as deterioration of a gate insulating layer does not occur at all. In other words, the memory element illustrated in FIG. 1B does not have a limitation on the number of write cycles, which is a problem of a conventional nonvolatile memory, and its reliability is markedly increased. Furthermore, data is written depending on the on/off state of the transistor, whereby high-speed operation can be easily achieved.

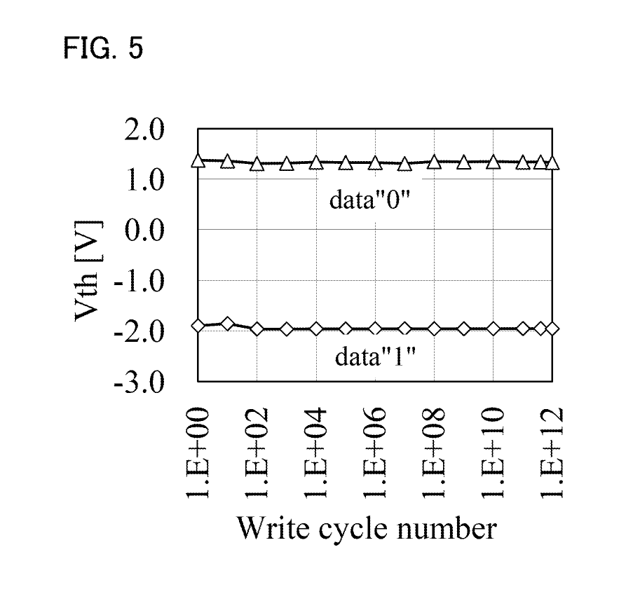

FIG. 5 is a graph showing the number of memory write cycles (on the horizontal axis) versus change in threshold voltage Vth of the first transistor 111 at the time when charge held in the gate electrode of the first transistor 111 is data‘1’ charge and data‘0’ charge (on the vertical axis). As shown in FIG. 5, whether data‘1’ charge or data‘0’ charge is held, the threshold voltage Vth of the first transistor 111 hardly changes depending on the write cycles. In other words, it is confirmed from FIG. 5 that the memory element illustrated in FIG. 1B has no limitation on the number of write cycles, which is a problem of a conventional nonvolatile memory, and its reliability is markedly increased.

Update of the lookup table in the memory circuit 106 is considered. When the external environment is constantly changed, it is preferable that the lookup table be generated each time the external environment is changed and be stored in the memory circuit 106 in order to increase the display quality of the display device. Consequently, the lookup table needs to be generated in a period different from a period during which image signals are corrected while referring the lookup table. Specifically, as has been described, the lookup table needs to be generated and stored in the memory circuit 106 in a retrace period.

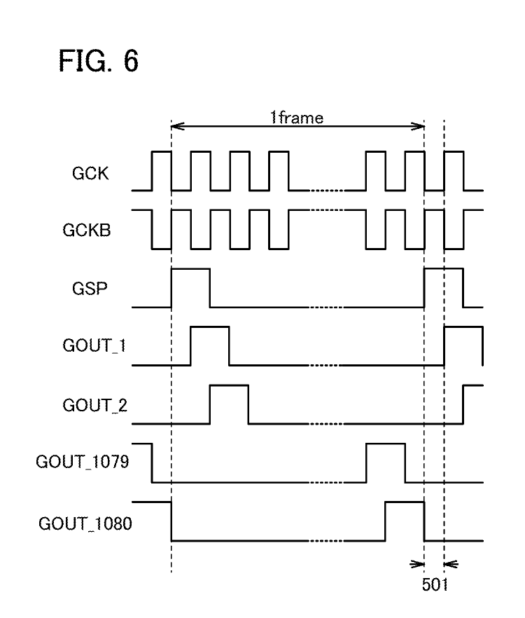

This is because if the lookup table is updated while images are displayed, image signals are not normally corrected, which causes display defects. For explanation, FIG. 6 illustrates an example of the operation of vertical scan lines (GOUT_{—}1 to GOUT_{—}1080) in a Full HD display panel (1920 columns×1080 rows).

The vertical scan lines GOUT_{—}1 to GOUT_{—}1080 are sequentially selected in synchronization with a clock pulse GCK and an inverted clock pulse GCKB using a start pulse GSP as a reference. In this example, a vertical retrace period 501 after GOUT_{—}1080 is selected until GOUT_{—}1 is selected again is half the cycle of the clock pulse GCK.

For example, when the frame frequency is 60 frames/second, the vertical retrace period 501 is approximately 16 μs, during which data of the lookup table stored in the memory circuit 106 needs to be rewritten. In a flash memory, erase operation is always required for data rewriting, so that it takes several milliseconds to perform rewrite operation. There have recently been many display panels with higher frame frequency; thus, the time it takes to rewrite the lookup table stored in the memory circuit 106 is shorter.

Considering the fact that the external environment is constantly changed, it is necessary that the lookup table can be rewritten each time the external environment is changed. In this respect also, a flash memory, which has low write endurance, is therefore not suitable for the circuit having a function of storing a lookup table that is constantly reconstructed in accordance with a change in the external environment.

On the other hand, the memory element illustrated in FIG. 1B does not need erase operation as in a flash memory and has a high rewrite speed of 1 μs or less, and thus provides performance high enough to rewrite data of the lookup table in the vertical retrace period 501. Moreover, since voltage necessary for data rewiring is low in the memory element illustrated in FIG. 1B, it is not necessary to additionally provide a step-up circuit or the like, thereby achieving the low-power memory circuit 106.

The configuration of the memory circuit 106 will be described with reference to a block diagram.

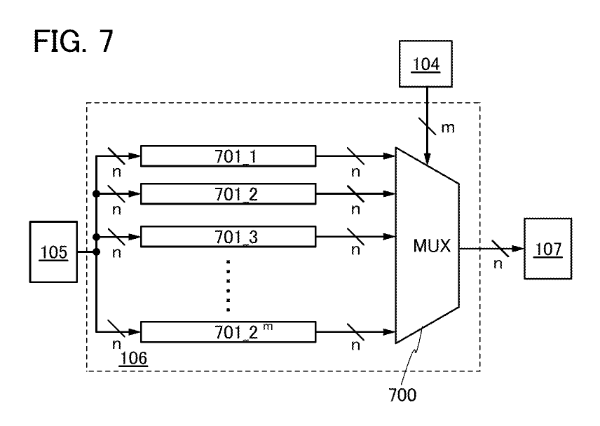

The memory circuit 106 illustrated in FIG. 7 includes memory blocks 701_{—}1 to 701_{—}2^{m} and a multiplexer circuit 700.

FIG. 7 shows the case where an image signal that is input from the display control circuit 104 and has not yet been corrected is an m-bit image signal and the m-bit image signal is converted into an n-bit image signal by being corrected in accordance with the lookup table.

In each of the 2^{m} memory blocks 701_{—}1 to 701_{—}2^{m}, data of an n-bit lookup table is stored by the memory control circuit 105. The multiplexer circuit 700 selects one of the 2^{m} memory blocks 701_{—}1 to 701_{—}2^{m} in accordance with an m-bit image signal input from the display control circuit 104. The corrected n-bit image signal is output to the image signal output circuit 107.

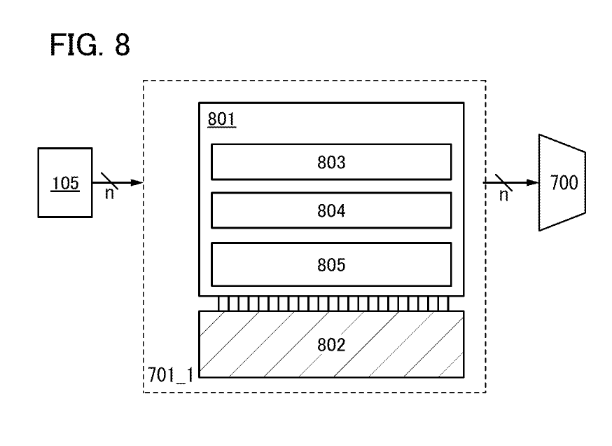

Then, the 2^{m} memory blocks 701_{—}1 to 701_{—}2^{m} will be described with reference to FIG. 8. FIG. 8 illustrates the memory block 701_{—}1 among the 2^{m} memory blocks 701_{—}1 to 701_{—}2^{m}.

In the block diagram illustrated in FIG. 8, data of the n-bit lookup table is stored in the memory block 701_{—}1 by the memory control circuit 105 as in FIG. 7. Then, when the data of the n-bit lookup table stored in the memory block 701_{—}1 is selected by the multiplexer circuit 700, the corrected n-bit image signal is output to the image signal output circuit 107.

The memory block 701_{—}1 includes a memory cell array driver circuit 801 and a memory cell array 802. The memory cell array driver circuit 801 includes a decoder 803, a page buffer 804, and a read circuit 805.

In order to store data of the n-bit lookup table in the memory block 701_{—}1, the data is temporarily held in the page buffer 804, and then stored in the memory cell array 802 by control of the decoder 803. In order to read data of the n-bit lookup table stored in the memory cell array 802, the data is output to the multiplexer circuit 700 through the read circuit 805.

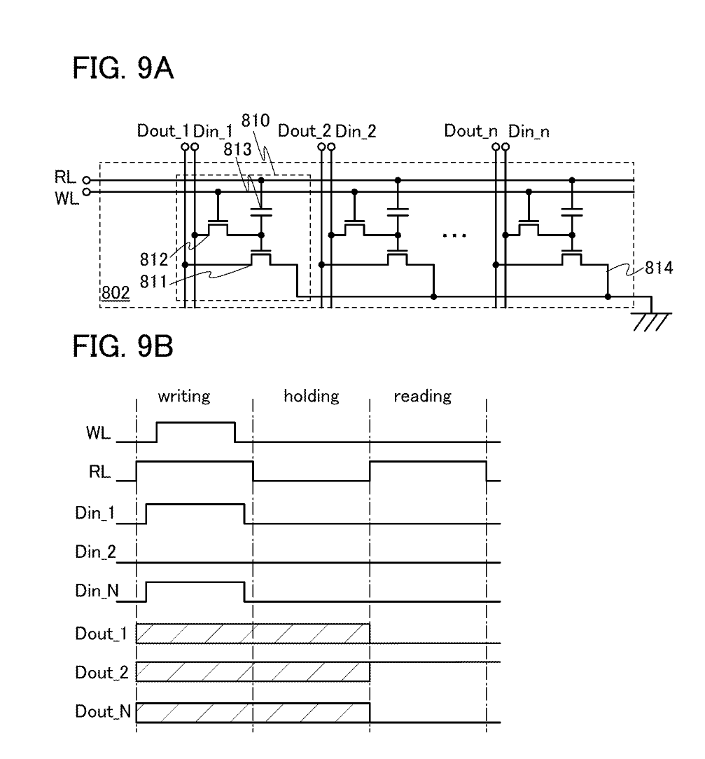

FIG. 9A illustrates a specific configuration of the memory cell array 802 illustrated in FIG. 8; the memory cell array 802 includes n memory elements in FIG. 1B in the row direction. A memory element 810 for storing 1-bit data includes a first transistor 811, a second transistor 812, and a capacitor 813.

The memory cell array 802 illustrated in FIG. 9A includes a variety of wirings such as n input data lines Din_{—}1 to Din_n, n output data lines Dout_{—}1 to Dout_n, a write word line WL, and a read word line RL. Signals or power supply potentials are supplied from the memory cell array driver circuit 801 or the memory control circuit 105 through these wirings to the memory elements 810.

A connection of these wirings and the components of the memory cell array 802 will be described using, as an example, the memory element 810 that is connected to the input data line Din_{—}1, the output data line Dout_{—}1, the write word line WL, and the read word line RL. A gate electrode of the second transistor 812 is connected to the write word line WL. One electrode of the second transistor 812 is connected to the input data line Din_{—}1, and the other electrode thereof is connected to a gate electrode of the first transistor 811. The gate electrode of the first transistor 811 is connected to one electrode of the capacitor 813. The other electrode of the capacitor 813 is connected to the read word line RL. One electrode of the first transistor 811 is connected to the output data line Dout_{—}1, and the other electrode thereof is connected to a power supply line 814 supplied with a fixed potential such as a ground potential.

Next, the operation of the memory block 701_{—}1 including the memory cell array 802 illustrated in FIG. 9A will be described with reference to FIG. 9B. FIG. 9B is a timing chart showing a change in the potential of signals input to the wirings over time. FIG. 9B illustrates the case where the first transistor 811 and the second transistor 812 are n-channel transistors and binary data is used.

First, the operation of the memory block 701_{—}1 at the time of data writing will be described. In data writing, first, signals containing data to be written are input to the input data lines Din_{—}1 to Din_n. FIG. 9B illustrates the case where high-level signals are input to the input data lines Din_{—}1 and Din_n, and a low-level signal is input to the input data line Din_{—}2. Needless to say, the levels of the potentials of signals input to the input data lines Din_{—}1 to Din_n vary depending on the contents of data.

Next, when a signal with a pulse is input to the write word line WL to write data, the potential of the pulse, specifically, a high-level potential is supplied to the gate electrode of the second transistor 812. Then, all the second transistors 812 whose gate electrodes are connected to the write word line WL are turned on. Further, the read word line RL is supplied with the potential V₀, which is the potential between Vₜₕ_{_{—}}_{H} and Vₜₕ_{_{—}}_{L} described using FIG. 1B and is the same as that applied in data reading. The potential of the read word line RL is controlled in data writing, whereby the potential of the gate electrode of the first transistor 811 can be prevented from being raised by capacitive coupling via the capacitor 813 at the time of data reading. Note that the potential of the read word line RL may be set at low level in writing and reading data.

Then, the potentials input to input data lines Din_{—}1 to Din_n are applied to the gate electrodes of the first transistors 811 through the second transistors 812 in the on state. Specifically, since the high-level signals are input to the input data lines Din_{—}1 and Din_n, the potential of the gate electrode of the first transistor 811 is at high level in the memory elements 810 connected to the input data lines Din_{—}1 and Din_n. That is, the first transistor 811 in these memory elements 810 operates in accordance with the plot of data‘1’ in FIG. 4. On the other hand, since the low-level signal is input to the input data line Din_{—}2, the potential of the gate electrode of the first transistor 811 is at low level in the memory element 810 connected to the input data line Din_{—}2. That is, the first transistor 811 in this memory element 810 operates in accordance with the plot of data‘0’ in FIG. 4.

When the input of a signal with a pulse to the write word line WL is finished, all the second transistors 812 whose gate electrodes are connected to the write word line WL are turned off.

Next, the operation of the memory block 701_{—}1 at the time of data retention will be described. In data retention, the write word line WL is supplied with a potential at which the second transistor 812 is turned off, specifically, a low-level potential. Since the off-state current of the second transistor 812 is extremely low as described above, the potential of the gate electrode of the first transistor 811 is kept at the level set in data writing. The read word line RL is supplied with a low-level potential.

In the timing chart in FIG. 9B, a retention period is provided in order to describe the operation of holding data. However, a retention period is not necessarily provided for actual operation of a memory.

Next, the operation of the memory block 701_{—}1 at the time of data reading will be described. In data reading, as in data retention, the write word line WL is supplied with a potential at which the second transistor 812 is turned off, specifically, a low-level potential. Moreover, in data reading, the read word line RL is supplied with the potential V₀, which is the potential between Vₜₕ_{_{—}}_{H} and Vₜₕ_{_{—}}_{L} described using FIG. 1B. Specifically, first, the potential V₀ is input to the read word line RL, so that the potential of the gate electrode of the first transistor 811 is raised by capacitive coupling of the capacitor 813, and a potential that is higher than Vₜₕ_{_{—}}_{H} and lower than Vₜₕ_{_{—}}_{L} or a potential higher than Vₜₕ_{_{—}}_{L} is given to the gate electrode of the first transistor 811. When the gate electrode of the first transistor 811 is supplied with a potential that is higher than Vₜₕ_{_{—}}_{H} and lower than Vₜₕ_{_{—}}_{L} or a potential higher than Vₜₕ_{_{—}}_{L}, the drain current or the resistance between the source and drain electrodes of the first transistor 811 is determined.

Then, a potential including the amount of the drain current or the resistance between the source and drain electrodes of the first transistor 811 as data, that is, the potential of the electrode, connected to the output data lines Dout_{—}1 to Dout_n, of the first transistor 811 is supplied to the memory cell array driver circuit 801 through the output data lines Dout_{—}1 to Dout_n.

Note that the levels of potentials supplied to the output data lines Dout_{—}1 to Dout_n are determined in accordance with data written into the memory elements 810. Consequently, when data with the same value is stored in a plurality of memory elements 810, potentials with the same level should ideally be supplied to all the output data lines Dout_{—}1 to Dout_n connected to these memory elements 810. However, practically, the characteristics of the first transistors 811 or the second transistors 812 sometimes may vary among the memory elements, in which case the potentials supplied to the output data lines may vary and be distributed in a wider range even if all of data to be read have the same value. Thus, it is preferable to provide the read circuit 805, which can generate a signal that contains data read from the potentials supplied to the output data lines Dout_{—}1 to Dout_n even when the potentials vary slightly, and has an amplitude and a waveform processed in accordance with the desired specification.

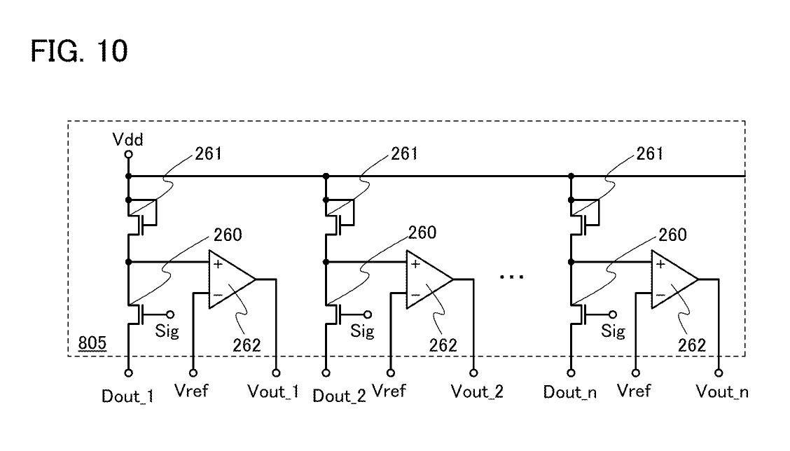

FIG. 10 illustrates an example of a circuit diagram of the read circuit 805. The read circuit 805 illustrated in FIG. 10 includes transistors 260 that function as switching elements for controlling input of the potentials of the output data lines Dout_{—}1 to Dout_n read from the memory cell array 802 to the read circuit 805, and transistors 261 that function as resistors. The read circuit 805 illustrated in FIG. 10 also includes operational amplifiers 262.

Specifically, a gate electrode and a drain electrode of the transistor 261 are connected to each other and supplied with a high-level power supply potential Vdd. A source electrode of the transistor 261 is connected to a non-inverting input terminal (+) of the operational amplifier 262. Accordingly, the transistor 261 functions as a resistor connected between a node to which the power supply potential Vdd is supplied and the non-inverting input terminal (+) of the operational amplifiers 262. A transistor whose gate electrode and drain electrode are connected to each other is used as a resistor in FIG. 10; however, the present invention is not limited thereto, and any element functioning as a resistor can be alternatively used.

Gate electrodes of the transistors 260 functioning as switching elements are connected to data lines. Supply of the potentials of the output data lines Dout_{—}1 to Dout_n to the source electrodes of the transistors 260 is controlled in accordance with signals Sig of the data lines.

When the transistor 260 connected to the data line is turned on, a potential obtained by dividing the potential of one of the output data lines Dout_{—}1 to Dout_n and the power supply potential Vdd by the resistances of the transistors 260 and 261 is supplied to the non-inverting input terminal (+) of the operational amplifier 262. Since the level of the power supply potential Vdd is fixed, the level of the potential obtained by the resistive division reflects the potential level of the output data lines Dout_{—}1 to Dout_n, that is, a digital value of read data.

A reference potential Vref is supplied to an inverting input terminal (−) of the operational amplifier 262. The level of a potential Vout of an output terminal can vary whether the potential applied to the non-inverting input terminal (+) is higher or lower than the reference potential Vref. Thus, a signal that indirectly contains data can be obtained.

As described above, one embodiment of the present invention can provide a display device driver circuit in which a lookup table can be written into a memory circuit within a retrace period even when the lookup table is constantly reconstructed in accordance with a change in the external environment and stored in the memory circuit, and data of the lookup table can be held even if supply of power supply voltage stops.

This embodiment can be implemented in appropriate combination with the structures described in the other embodiments.

### Embodiment 2

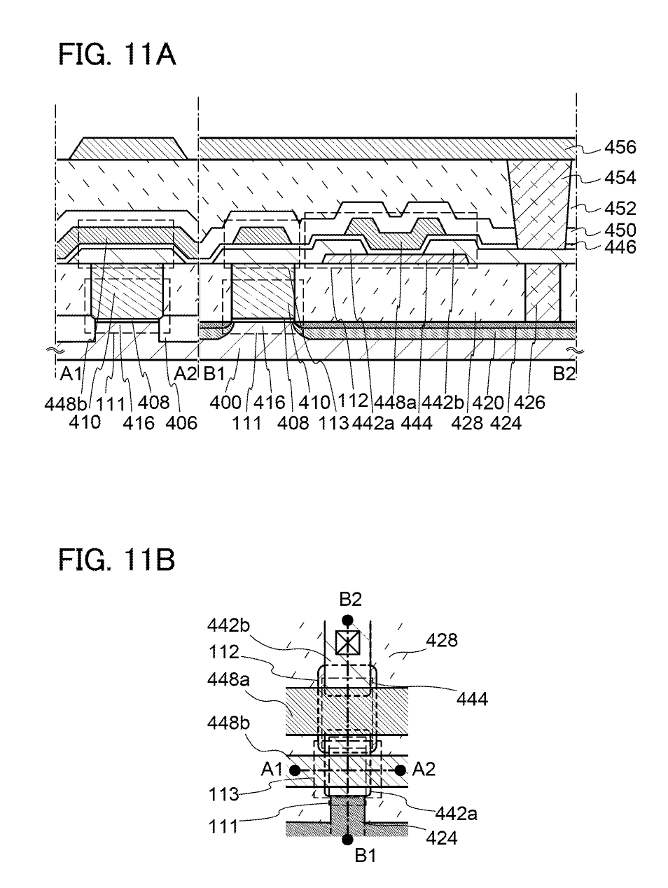

In this embodiment, a structure and a fabrication method of a memory element included in a display device driver circuit according to one embodiment of the disclosed invention will be described with reference to FIGS. 11A and 11B, FIGS. 12A to 12D, FIGS. 13A to 13D, FIGS. 14A to 14D, and FIGS. 15A and 15B.

### <Cross-Sectional Structure and Plan View of Memory Element>

FIGS. 11A and 11B illustrate a structure example of the memory element included in a driver circuit for a display device. FIGS. 11A and 11B illustrate a cross section and a plan view, respectively, of the memory element included in a driver circuit for a display device. In FIG. 11A, the cross section A1-A2 is perpendicular to the channel length direction of a transistor, and the cross section B1-B2 is parallel to the channel length direction of the transistor. In the memory element illustrated in FIGS. 11A and 11B, the first transistor 111, in which single crystal silicon is used for the semiconductor layer, is provided in a lower portion and the second transistor 112, in which an oxide semiconductor is used for the semiconductor layer, is provided in an upper portion.

The first transistor 111 includes a channel formation region 416 provided in a substrate 400 containing single crystal silicon, impurity regions 420 (also referred to as a source region and a drain region) provided so that the channel formation region 416 is placed therebetween, intermetallic compound regions 424 in contact with the impurity regions 420, a gate insulating layer 408 provided over the channel formation region 416, and a gate electrode 410 provided over the gate insulating layer 408.

An electrode 426 is connected to part of the intermetallic compound region 424 of the first transistor 111. Here, the electrode 426 functions as one electrode of the first transistor 111. An element isolation insulating layer 406 is provided over the substrate 400 so as to surround the first transistor 111, and an insulating layer 428 is provided in contact with the first transistor 111.

The second transistor 112 includes an oxide semiconductor layer 444 provided over the insulating layer 428 and the like, one electrode 442a and the other electrode 442b that are connected to the oxide semiconductor layer 444, a gate insulating layer 446 covering the oxide semiconductor layer 444 and the electrodes 442a and 442b, and a gate electrode 448a provided over the gate insulating layer 446 to overlap the oxide semiconductor layer 444 (i.e., provided to overlap the oxide semiconductor layer 444 with the gate insulating layer 446 placed therebetween).

Here, the oxide semiconductor layer 444 included in the second transistor 112 is preferably highly purified by sufficient removal of impurities such as hydrogen and sufficient supply of oxygen as described in Embodiment 1. For example, the hydrogen concentration of the oxide semiconductor layer 444 is 5×10¹⁹ atoms/cm³ or lower, preferably 5×10¹⁸ atoms/cm³ or lower, further preferably 5×10¹⁷ atoms/cm³ or lower. Note that the hydrogen concentration of the oxide semiconductor layer 444 is measured by secondary ion mass spectrometry (SIMS).

The capacitor 113 is composed of the electrode 442a, the gate insulating layer 446, and a conductive layer 448b. In other words, the electrode 442a functions as one electrode of the capacitor 113, and the conductive layer 448b functions as the other electrode of the capacitor 113.

An insulating layer 450 and an insulating layer 452 are provided over the second transistor 112 and the capacitor 113. An electrode 454 is provided in an opening formed in the gate insulating layer 446, the insulating layer 450, the insulating layer 452, and the like. A wiring 456 connected to the electrode 454 is formed over the insulating layer 452.

In FIGS. 11A and 11B, the electrode 454 for connecting the wiring 456 and the electrode 442b is provided to overlap the electrode 426 for connecting the electrode 442b and the intermetallic compound region 424. That is, a region where the electrode 454 is in contact with the electrode 442b of the second transistor 112 overlaps a region where the electrode 442b of the second transistor 112 is in contact with the electrode 426 functioning as a source electrode or a drain electrode of the first transistor 111. With such a planar layout, the element area can be prevented from increasing due to contact regions of the electrodes. In other words, the degree of integration of the memory elements can be increased.

In FIGS. 11A and 11B, the first transistor 111 and the second transistor 112 are provided to overlap each other at least partly. In addition, the second transistor 112 and the capacitor 113 are provided to overlap the first transistor 111. For example, the conductive layer 448b of the capacitor 113 is provided so as to overlap the gate electrode 410 of the first transistor 111 at least partly. By employing such a planar layout, high integration of the memory elements can be achieved.

### <Method for Fabricating Memory Element Included in Driver Circuit for Display Device>

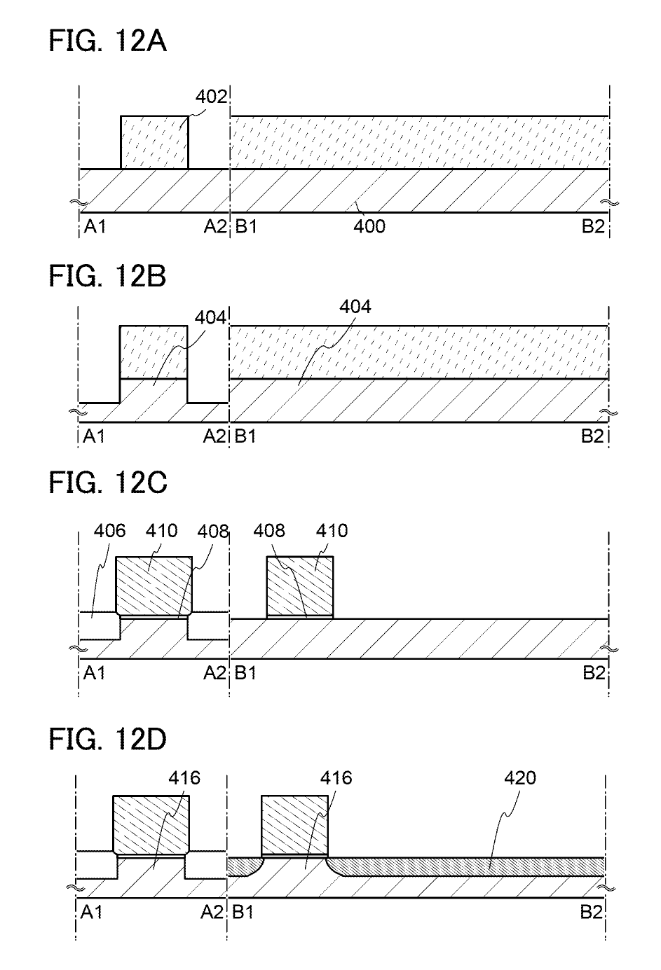

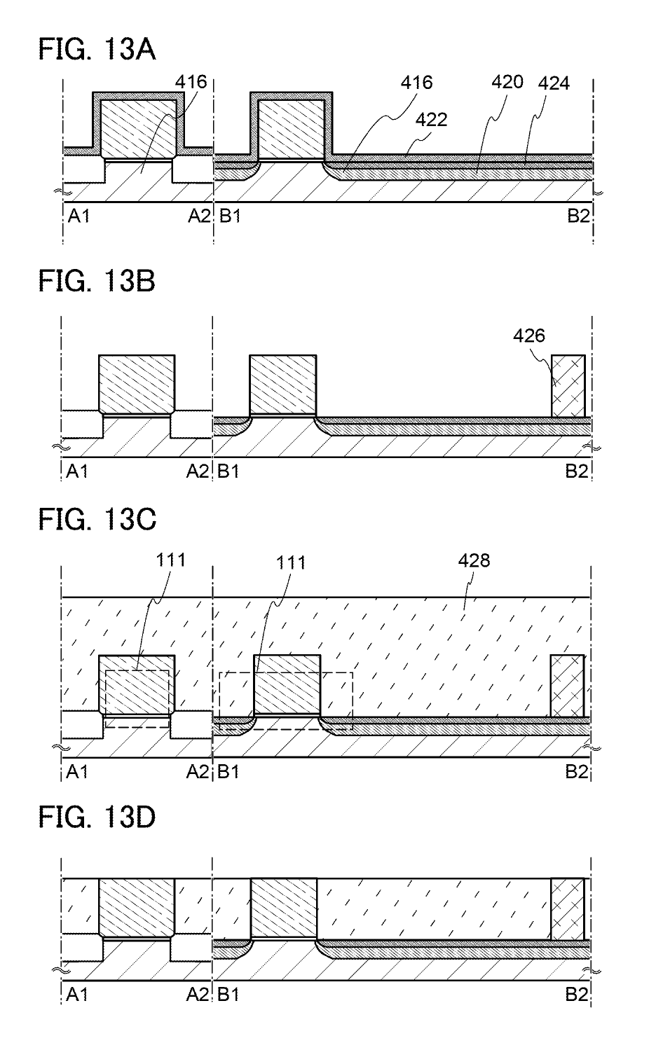

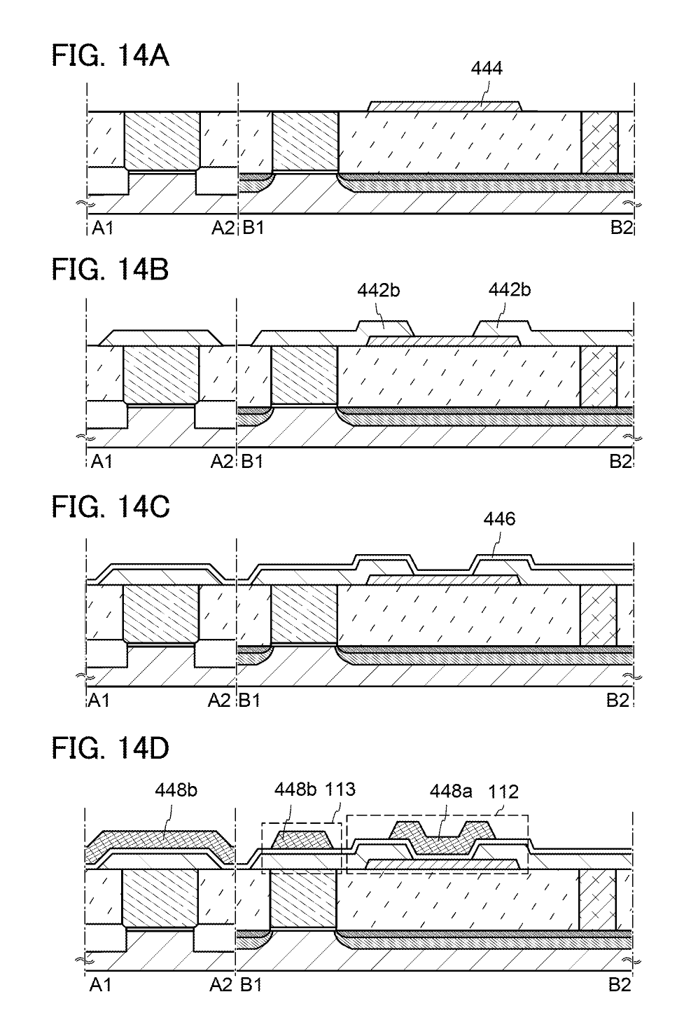

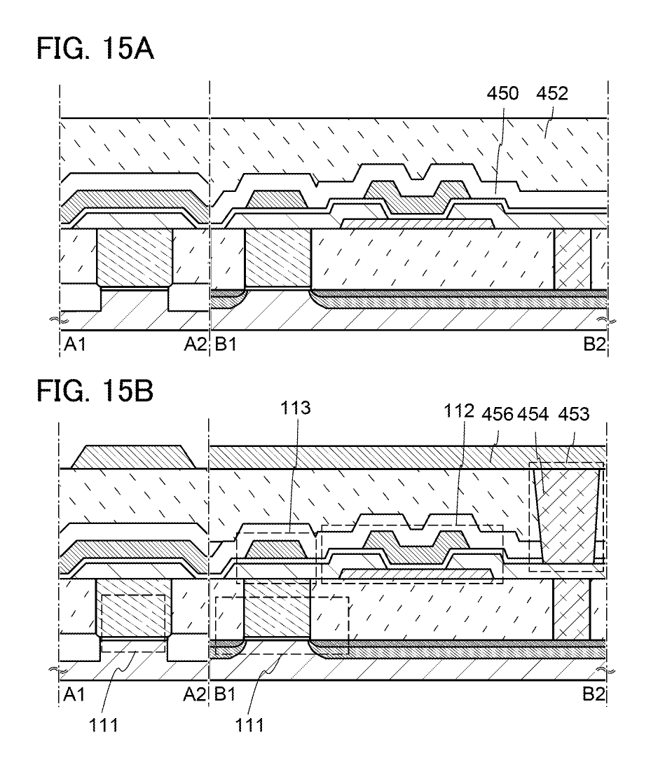

Next, an example of a method for fabricating the memory element included in the driver circuit for a display device will be described. First, a method for fabricating the first transistor 111 in the lower portion is described with reference to FIGS. 12A to 12D and FIGS. 13A to 13D; then, a method for fabricating the second transistor 112 in the upper portion and the capacitor 113 will be described with reference to FIGS. 14A to 14D and FIGS. 15A and 15B.

### <Method for Fabricating Lower Transistor>

A method for fabricating the first transistor 111 in the lower portion will be described with reference to FIGS. 12A to 12D and FIGS. 13A to 13D.

First, the substrate 400 containing a semiconductor material is prepared. Examples of the substrate containing a semiconductor material are a single crystal semiconductor substrate and a polycrystalline semiconductor substrate of silicon, silicon carbide, or the like; a compound semiconductor substrate of silicon germanium or the like; and an SOI substrate. An example of the case where a single crystal silicon substrate is used as the substrate 400 containing a semiconductor material is described here.

As the substrate 400 containing a semiconductor material, a single crystal semiconductor substrate of silicon or the like is preferably used because the speed of read operation of the memory element can be increased.

A protective layer 402 serving as a mask for forming an element isolation insulating layer is formed over the substrate 400 (see FIG. 12A). As the protective layer 402, an insulating layer formed using silicon oxide, silicon nitride, or silicon oxynitride can be used, for example.

Next, part of the substrate 400 in a region that is not covered with the protective layer 402 (i.e., in an exposed region) is removed by etching with the use of the protective layer 402 as a mask. Thus, a semiconductor region 404 isolated from other semiconductor regions is formed (see FIG. 12B).

Then, an insulating layer is formed so as to cover the semiconductor region 404, and the insulating layer in a region overlapping the semiconductor region 404 is selectively removed; thus, the element isolation insulating layer 406 is formed (see FIG. 12C). The insulating layer is formed using silicon oxide, silicon nitride, silicon oxynitride, or the like. For removing the insulating layer, any of etching treatment, polishing treatment such as chemical mechanical polishing (CMP), and the like can be employed. Note that the protective layer 402 is removed either after the semiconductor region 404 is formed or after the element isolation insulating layer 406 is formed.

Next, an insulating layer is formed on a surface of the semiconductor region 404, and a layer containing a conductive material is formed over the insulating layer.

The insulating layer serves as a gate insulating layer later and can be formed by heat treatment (thermal oxidation treatment, thermal nitridation treatment, or the like) of the surface of the semiconductor region 404, for example. Instead of heat treatment, high-density plasma treatment may be employed. The high-density plasma treatment can be performed using, for example, a mixed gas of any of a rare gas such as He, Ar, Kr, or Xe, oxygen, nitrogen oxide, ammonia, nitrogen, and hydrogen. Needless to say, the insulating layer may be formed by CVD, sputtering, or the like. The insulating layer preferably has a single-layer structure or a stacked structure including a film of any of silicon oxide, silicon oxynitride, silicon nitride, hafnium oxide, aluminum oxide, tantalum oxide, yttrium oxide, hafnium silicate (HfSiₓO_{y} (x>0, y>0)), hafnium silicate (HfSiₓO_{y} (x>0, y>0)) to which nitrogen is added, hafnium aluminate (HfAlₓO_{y} (x>0, y>0)) to which nitrogen is added, and the like. The insulating layer can have a thickness of, for example, 1 nm to 100 nm, preferably 10 nm to 50 nm.

The layer containing a conductive material can be formed using a metal material such as aluminum, copper, titanium, tantalum, or tungsten. Alternatively, the layer containing a conductive material may be formed using a semiconductor material such as polycrystalline silicon. There is no particular limitation on the method for forming the layer containing a conductive material, and any of a variety of film formation methods such as evaporation, CVD, sputtering, and spin coating can be employed. Note that this embodiment shows an example of the case where the layer containing a conductive material is formed using a metal material.

After that, the insulating layer and the layer containing a conductive material are selectively etched, so that the gate insulating layer 408 and the gate electrode 410 are formed (see FIG. 12C).

Next, phosphorus (P), arsenic (As), or the like is added to the semiconductor region 404, so that the channel formation region 416 and the impurity regions 420 are formed (see FIG. 12D). Note that phosphorus or arsenic is added here in order to form an n-channel transistor; alternatively, an impurity element such as boron (B) or aluminum (Al) may be added to form a p-channel transistor.

Note that a sidewall insulating layer may be formed around the gate electrode 410 so that impurity regions to which the impurity element is added at different concentrations may be formed.

Then, a metal layer 422 is formed so as to cover the gate electrode 410, the impurity regions 420, and the like (see FIG. 13A). The metal layer 422 can be formed by any of a variety of film formation methods such as vacuum evaporation, sputtering, and spin coating. The metal layer 422 is preferably formed using a metal material that forms a low-resistance metal compound by reacting with a semiconductor material included in the semiconductor region 404. Examples of such a metal material are titanium, tantalum, tungsten, nickel, cobalt, and platinum.

Next, heat treatment is performed so that the metal layer 422 reacts with the semiconductor material. Thus, the intermetallic compound regions 424 in contact with the impurity regions 420 are formed (see FIG. 13A). When the gate electrode 410 is formed using polycrystalline silicon or the like, an intermetallic compound region is also formed in a region of the gate electrode 410 in contact with the metal layer 422.

As the heat treatment, irradiation with a flash lamp can be employed, for example. Although another heat treatment method may be used, a method by which heat treatment can be achieved in an extremely short time is preferably used in order to improve the controllability of chemical reaction for formation of the intermetallic compound. Note that the intermetallic compound regions are formed by reaction of the metal material and the semiconductor material and have sufficiently high conductivity. The formation of the intermetallic compound regions can properly reduce the electric resistance and improve element characteristics. Note that the metal layer 422 is removed after the intermetallic compound regions 424 are formed.

Then, the electrode 426 is formed in a region that is in contact with part of the intermetallic compound region 424 (see FIG. 13B). The electrode 426 is formed by, for example, forming a layer containing a conductive material and then selectively etching the layer. The layer containing a conductive material can be formed using a metal material such as aluminum, copper, titanium, tantalum, or tungsten. Alternatively, the layer containing a conductive material may be formed using a semiconductor material such as polycrystalline silicon. There is no particular limitation on the method for forming the layer containing a conductive material, and any of a variety of film formation methods such as evaporation, CVD, sputtering, and spin coating can be employed.

Next, the insulating layer 428 is formed so as to cover the components formed in the above steps (see FIG. 13C). The insulating layer 428 can be formed using a material including an inorganic insulating material such as silicon oxide, silicon oxynitride, silicon nitride, or aluminum oxide.

Through the above process, the first transistor 111 using the substrate 400 containing a semiconductor material is formed (see FIG. 13C). The first transistor 111 features high-speed operation. Thus, when the transistor is used as a reading transistor, data can be read at high speed.

After that, as treatment performed before the second transistor 112 and the capacitor 113 are formed, CMP treatment is performed on the insulating layer 428 so that upper surfaces of the gate electrode 410 and the electrode 426 are exposed (see FIG. 13D). Although it is possible to employ etching treatment or the like other than CMP treatment to expose the upper surfaces of the gate electrode 410 and the electrode 426, it is preferable to planarize the surface of the insulating layer 428 as much as possible in order to improve the characteristics of the second transistor 112.

### <Method for Fabricating Upper Transistor>

Next, a method for fabricating the second transistor 112 in the upper portion and the capacitor 113 will be described with reference to FIGS. 14 to 14D and FIGS. 15A and 15B.

First, an oxide semiconductor layer is formed over the gate electrode 410, the electrode 426, the conductive layer 428, and the like and is processed, so that the oxide semiconductor layer 444 is formed (see FIG. 14A).

As the oxide semiconductor, any material described in Embodiment 1 can be used.

In this embodiment, the oxide semiconductor layer is formed by sputtering using an In—Ga—Zn-based oxide semiconductor deposition target. As a target for forming the oxide semiconductor layer by sputtering, for example, a metal oxide target having a composition ratio of In₂O₃:Ga₂O₃:ZnO=1:1:1 [molar ratio] is used to form an In—Ga—Zn—O layer.

The deposition atmosphere may be a rare gas (typically argon) atmosphere, an oxygen atmosphere, or a mixed atmosphere containing a rare gas and oxygen. An atmosphere of a high-purity gas from which impurities such as hydrogen, water, a hydroxyl group, or hydride is removed is preferable in order to prevent hydrogen, water, a hydroxyl group, hydride, or the like from entering the oxide semiconductor layer.

For example, the oxide semiconductor layer can be formed as follows.

First, the substrate is held in a deposition chamber kept under reduced pressure, and then is heated so that the substrate temperature reaches a temperature higher than 100° C. and lower than or equal to 600° C., preferably higher than 300° C. and lower than or equal to 500° C.

By heating the substrate during deposition, the concentration of impurities such as hydrogen, moisture, hydride, or a hydroxyl group in the oxide semiconductor layer can be reduced. In addition, damage by sputtering can be reduced. Then, a sputtering gas from which hydrogen and moisture are removed is introduced into the deposition chamber while moisture remaining therein is removed, and the oxide semiconductor layer is formed with the use of the above target.

In order to remove moisture remaining in the deposition chamber, an entrapment vacuum pump such as a cryopump, an ion pump, or a titanium sublimation pump is preferably used. An exhaustion unit may be a turbo molecular pump provided with a cold trap. In the deposition chamber which is evacuated with the cryopump, a hydrogen atom, a compound containing a hydrogen atom, such as water (H₂O), (more preferably, also a compound containing a carbon atom), and the like are evacuated, whereby the concentration of impurities in the oxide semiconductor layer formed in the deposition chamber can be reduced.

An example of the film formation condition is as follows: the distance between the substrate and the target is 100 mm, the pressure is 0.6 Pa, the direct-current (DC) power is 0.5 kW, and oxygen (the flow rate ratio of oxygen is 100%) is used as a sputtering gas. Note that a pulsed direct-current power source is preferably used, in which case powder substances (also referred to as particles or dust) that are generated in deposition can be reduced and the film thickness can be uniform.

After that, heat treatment (first heat treatment) may be performed on the oxide semiconductor layer 444. By the first heat treatment, excessive hydrogen (including water and a hydroxyl group) in the oxide semiconductor layer is removed (dehydrated or dehydrogenated), whereby the impurity concentration in the oxide semiconductor layer can be reduced.

The first heat treatment is preferably performed at a temperature higher than or equal to 250° C. and lower than or equal to 750° C., or higher than or equal to 400° C. and lower than the strain point of the substrate in a reduced pressure atmosphere, an inert gas atmosphere such as a nitrogen atmosphere or a rare gas atmosphere, an oxygen gas atmosphere, or an ultra dry air atmosphere (with a moisture content of 20 ppm (the dew point: −55° C.) or less, preferably 1 ppm or less, more preferably 10 ppb or less in the case where measurement is performed using a dew-point meter of a cavity ring-down laser spectroscopy (CRDS) system).

The heat treatment can be performed in such a way that, for example, an object to be heated is introduced into an electric furnace using a resistance heating element or the like and heated at 450° C. for 1 hour in a nitrogen atmosphere. The oxide semiconductor layer 444 is not exposed to the air during the heat treatment so that entry of water and hydrogen can be prevented.

In a transistor including an oxide semiconductor that is highly purified by sufficient reduction in hydrogen concentration by heat treatment, the electrical characteristics such as threshold voltage and on-state current are nearly independent of temperature, and the change in transistor characteristics due to deterioration by light is small. As a result, a transistor with excellent properties can be provided.

Next, a conductive layer for forming a source electrode and a drain electrode (including a wiring formed using the same layer as the source and drain electrodes) is formed over the oxide semiconductor layer 444 and the like and is processed, so that the electrodes 442a and 442b are formed (see FIG. 14B).

The conductive layer can be formed by PVD or CVD. Examples of a material for the conductive layer are an element selected from aluminum, chromium, copper, tantalum, titanium, molybdenum, and tungsten and an alloy containing any of these elements as a component. Further, one or more materials selected from manganese, magnesium, zirconium, beryllium, neodymium, and scandium may be used.

Then, the gate insulating layer 446 is formed so as to cover the electrodes 442a and 442b and to be in contact with part of the oxide semiconductor layer 444 (see FIG. 14C).

The gate insulating layer 446 can be formed by CVD, sputtering, or the like. The gate insulating layer 446 is formed using silicon oxide, silicon nitride, silicon oxynitride, or the like. Alternatively, the gate insulating layer 446 can be formed using a material including an element of Group 13 and oxygen. Examples of the material including an element of Group 13 and oxygen are gallium oxide, aluminum oxide, and aluminum gallium oxide. Furthermore, the gate insulating layer 446 may be formed to include tantalum oxide, hafnium oxide, yttrium oxide, hafnium silicate (HfSiₓO_{y} (x>0, y>0)), hafnium silicate (HfSiₓO_{y} (x>0, y>0)) to which nitrogen is added, hafnium aluminate (HfAlₓO_{y} (x>0, y>0)) to which nitrogen is added, or the like. The gate insulating layer 446 may have a single-layer structure or a stacked structure in which the above materials are combined. There is no particular limitation on the thickness of the gate insulating layer 446; in the case where the memory element is miniaturized, the gate insulating layer 446 is preferably thin in order to ensure the operation of the transistor. For example, when silicon oxide is used, the gate insulating layer 446 can have a thickness of 1 nm to 100 nm, preferably 10 nm to 50 nm.

The gate insulating layer 446 is preferably formed by a method with which impurities such as nitrogen, hydrogen, and water do not enter the gate insulating layer 446. This is because, if impurities such as hydrogen and water are included in the gate insulating layer 446, the impurities such as hydrogen and water enter the oxide semiconductor layer or oxygen in the oxide semiconductor layer is extracted by the impurities such as hydrogen and water, so that a back channel of the oxide semiconductor layer might have lower resistance (have n-type conductivity) and a parasitic channel might be formed. Thus, the gate insulating layer 446 is preferably formed to include impurities such as hydrogen or water as few as possible. For example, the gate insulating layer 446 is preferably formed by sputtering. A high-purity gas from which impurities such as hydrogen and water are removed is preferably used as a sputtering gas for forming the gate insulating layer 446.

In addition, the gate insulating layer 446 preferably includes oxygen more than that in the stoichiometric composition. For example, when gallium oxide is used for the gate insulating layer 446, the stoichiometric composition can be expressed as Ga₂O_{3+α} (0<α<1). When aluminum oxide is used, the stoichiometric composition can be expressed as Al₂O_{3+α} (0<α<1). When gallium aluminum oxide is used, the stoichiometric composition can be expressed as GaₓAl₂₋ₓO_{3+α} (0<x<2, 0<α<1).

Note that oxygen doping treatment may be performed after the oxide semiconductor layer is formed, after the oxide semiconductor layer 444 is formed, or after the gate insulating layer 446 is formed. The oxygen doping means that oxygen (including at least one of an oxygen radical, an oxygen atom, and an oxygen ion) is added to a bulk. Note that the term “bulk” is used in order to clarify that oxygen is added not only to a surface of a thin film but also to the inside of the thin film. In addition, “oxygen doping” includes “oxygen plasma doping” in which oxygen made to be plasma is added to a bulk. With oxygen doping, the proportion of oxygen included in the oxide semiconductor layer and the gate insulating layer can be made larger than the stoichiometric proportion.

The oxygen doping treatment is preferably performed by an inductively coupled plasma (ICP) method, using oxygen plasma which is excited by a microwave (with a frequency of 2.45 GHz, for example).

After formation of the gate insulating layer 446, second heat treatment is preferably performed in an inert gas atmosphere or an oxygen atmosphere. The temperature of the heat treatment ranges from 200° C. to 450° C., preferably 250° C. to 350° C. For example, the heat treatment may be performed at 250° C. for 1 hour in a nitrogen atmosphere. The second heat treatment can reduce variation in electric characteristics of transistors. Further, in the case where the gate insulating layer 446 includes oxygen, oxygen can be supplied to the oxide semiconductor layer 444 and oxygen vacancies in the oxide semiconductor layer 444 can be filled; thus, an i-type (intrinsic) or substantially i-type oxide semiconductor layer can be formed.

Note that although the second heat treatment in this embodiment is performed after the gate insulating layer 446 is formed, the timing of the second heat treatment is not limited thereto. For example, the second heat treatment may be performed after the gate electrode is formed. Alternatively, the first heat treatment and the second heat treatment may be successively performed, the first heat treatment may double as the second heat treatment, or the second heat treatment may double as the first heat treatment.

As described above, at least one of the first heat treatment and the second heat treatment is employed, whereby the oxide semiconductor layer 444 can be highly purified so as to include a substance containing a hydrogen atom as few as possible.

Next, a conductive layer for forming a gate electrode (including a wiring formed using the same layer as the gate electrode) is formed and processed, so that the gate electrode 448a and the conductive layer 448b are formed (see FIG. 14D).

The gate electrode 448a and the conductive layer 448b can be formed using a metal material such as molybdenum, titanium, tantalum, tungsten, aluminum, copper, neodymium, or scandium or an alloy material containing any of these materials as a main component. Note that the gate electrode 448a and the conductive layer 448b may have a single-layer structure or a stacked structure.

Then, the insulating layer 450 and the insulating layer 452 are formed over the gate insulating layer 446, the gate electrode 448a, and the conductive layer 448b (see FIG. 15A). The insulating layer 450 and the insulating layer 452 can be formed by PVD, CVD, or the like. The insulating layer 450 and the insulating layer 452 can be formed using a material including an inorganic insulating material such as silicon oxide, silicon oxynitride, silicon nitride, hafnium oxide, gallium oxide, aluminum oxide, or gallium aluminum oxide.

Next, an opening 453 reaching the electrode 442b is formed in the gate insulating layer 446, the insulating layer 450, and the insulating layer 452. After that, the electrode 454 in contact with the electrode 442b is formed in the opening 453, and the wiring 456 in contact with the electrode 454 is formed over the insulating layer 452 (see FIG. 15B). The opening 453 is formed by selective etching using a mask or the like.

The electrode 454 can be formed in such a manner that, for example, a conductive layer is formed by PVD, CVD, or the like in a region including the opening 453 and then part of the conductive layer is removed by etching treatment, CMP treatment, or the like. Specifically, it is possible to employ a method, for example, in which a thin titanium film is formed in a region including the opening 453 by PVD and a thin titanium nitride film is formed by CVD, and then, a tungsten film is formed so as to be embedded in the opening 453.

The wiring 456 can be formed in such a manner that a conductive layer is formed by PVD such as sputtering or CVD such as plasma-enhanced CVD and then is patterned. Examples of a material for the conductive layer are an element selected from aluminum, chromium, copper, tantalum, titanium, molybdenum, and tungsten and an alloy containing any of these elements as a component. Further, one or more materials selected from manganese, magnesium, zirconium, beryllium, neodymium, and scandium may be used. The details are similar to those of the electrodes 442a and 442b and the like.

Through the above steps, the memory element including the first transistor 111, the second transistor 112, and the capacitor 113 is completed (see FIG. 15B).

This embodiment can be implemented in appropriate combination with the structures described in the other embodiments.

### Embodiment 3

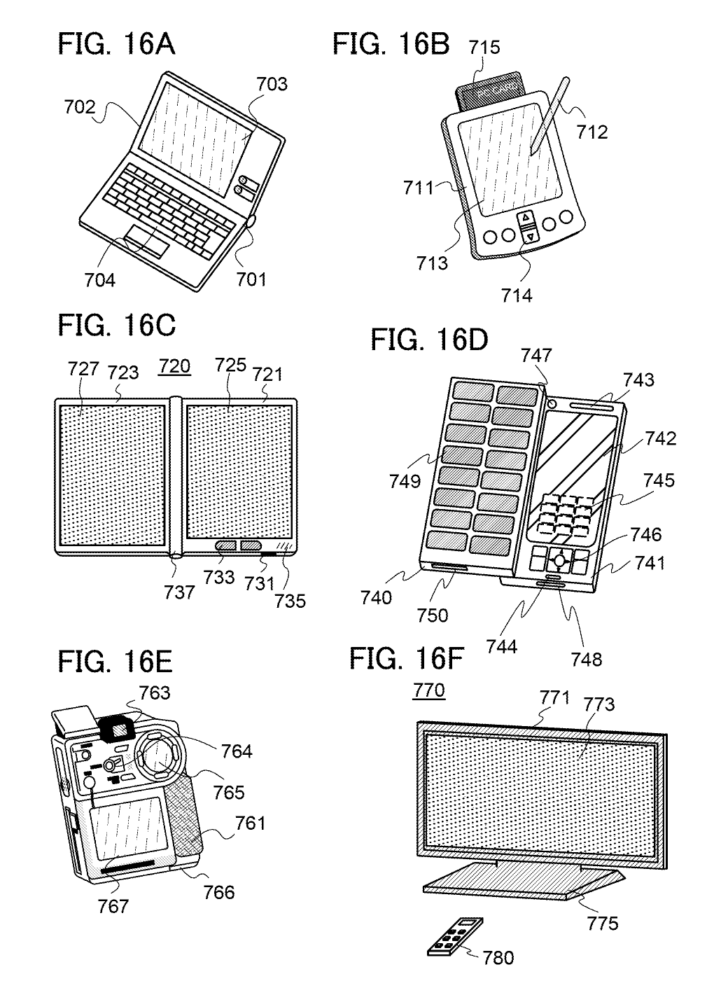

In this embodiment, electronic devices to which the display device driver circuit described in Embodiment 1 is applied will be described with reference to FIGS. 16A to 16F. Specifically, this embodiment explains the case where the driver circuit for a display device is applied to electronic devices such as computers, mobile phone sets (also referred to as mobile phones or mobile phone devices), personal digital assistants (including portable game machines and audio playback devices), cameras such as digital cameras and digital video cameras, electronic paper, and television sets (also referred to as televisions or television receivers).

FIG. 16A illustrates a laptop computer including a housing 701, a housing 702, a display portion 703, a keyboard 704, and the like. The display device driver circuit described in Embodiment 1 is provided in at least one of the housings 701 and 702. As a result, it is possible to achieve a laptop computer including the display device driver circuit, in which a lookup table can be written at high speed even when the lookup table is constantly reconstructed in accordance with a change in the external environment and stored in a memory circuit in order to increase the image quality of the display device, and data of the lookup table can be held even if supply of power supply voltage stops.

FIG. 16B illustrates a personal digital assistant (PDA). A main body 711 is provided with a display portion 713, an external interface 715, operation buttons 714, and the like. Further, a stylus 712 or the like for operating the personal digital assistant is provided. The display device driver circuit described in Embodiment 1 is provided in the main body 711. As a result, it is possible to achieve a personal digital assistant including the display device driver circuit, in which a lookup table can be written at high speed even when the lookup table is constantly reconstructed in accordance with a change in the external environment and stored in a memory circuit in order to increase the image quality of the display device, and data of the lookup table can be held even if supply of power supply voltage stops.

FIG. 16C illustrates an e-book reader 720 provided with electronic paper. The e-book reader 720 has two housings, a housing 721 and a housing 723. The housing 721 and the housing 723 are provided with a display portion 725 and a display portion 727, respectively. The housings 721 and 723 are connected by a hinge 737 and can be opened or closed with the hinge 737 as an axis. The housing 721 is provided with a power switch 731, an operation key 733, a speaker 735, and the like. The display device driver circuit described in Embodiment 1 is provided in at least one of the housings 721 and 723. It is thus possible to achieve an e-book reader including the display device driver circuit, in which a lookup table can be written at high speed even when the lookup table is constantly reconstructed in accordance with a change in the external environment and stored in a memory circuit in order to increase the image quality of the display device, and data of the lookup table can be held even if supply of power supply voltage stops.

FIG. 16D illustrates a mobile phone including two housings of a housing 740 and a housing 741. The housing 740 and the housing 741 in a state where they are developed as illustrated in FIG. 16D can shift by sliding so that one is lapped over the other; thus, the size of the mobile phone can be reduced, which makes the mobile phone suitable for being carried. The housing 741 is provided with a display panel 742, a speaker 743, a microphone 744, an operation key 745, a pointing device 746, a camera lens 747, an external connection terminal 748, and the like. The housing 740 is provided with a solar cell 749 for charging the mobile phone, an external memory slot 750, and the like. An antenna is incorporated in the housing 741. The display device driver circuit described in Embodiment 1 is provided in at least one of the housings 740 and 741. It is thus possible to achieve a mobile phone including the display device driver circuit, in which a lookup table can be written at high speed even when the lookup table is constantly reconstructed in accordance with a change in the external environment and stored in a memory circuit in order to increase the image quality of the display device, and data of the lookup table can be held even if supply of power supply voltage stops.

FIG. 16E illustrates a digital camera including a main body 761, a display portion 767, an eyepiece 763, an operation switch 764, a display portion 765, a battery 766, and the like. The display device driver circuit described in Embodiment 1 is provided in the main body 761. It is thus possible to achieve a digital camera including the display device driver circuit, in which a lookup table can be written at high speed even when the lookup table is constantly reconstructed in accordance with a change in the external environment and stored in a memory circuit in order to increase the image quality of the display device, and data of the lookup table can be held even if supply of power supply voltage stops.

FIG. 16F illustrates a television set 770 including a housing 771, a display portion 773, a stand 775, and the like. The television set 770 can be operated with a switch provided for the housing 771 or with a remote controller 780. The display device driver circuit described in Embodiment 1 is provided in the housing 771 and the remote controller 780. As a result, it is possible to achieve a television set including the display device driver circuit, in which a lookup table can be written at high speed even when the lookup table is constantly reconstructed in accordance with a change in the external environment and stored in a memory circuit in order to increase the image quality of the display device, and data of the lookup table can be held even if supply of power supply voltage stops.

As described above, the display device driver circuit according to Embodiment 1 is mounted on the electronic device described in this embodiment. As a result, it is possible to achieve an electronic device including the display device driver circuit, in which a lookup table can be written at high speed even when the lookup table is constantly reconstructed in accordance with a change in the external environment and stored in a memory circuit in order to increase the image quality of the display device, and data of the lookup table can be held even if supply of power supply voltage stops.

This embodiment can be implemented in appropriate combination with the structures described in the other embodiments.

This application is based on Japanese Patent Applications serial No. 2011-262571 filed with Japan Patent Office on Nov. 30, 2011, the entire contents of which are hereby incorporated by reference.

What is claimed is:

1. A display device comprising:
a driver circuit comprising a memory circuit,
wherein:
the memory circuit is configured to store a lookup table for correcting an image signal,
the memory circuit comprises a memory element including a first transistor, a second transistor, and a capacitor,
a gate electrode of the first transistor is connected to one electrode of the second transistor,
a semiconductor layer of the second transistor comprises an oxide semiconductor, and
one electrode of the capacitor is connected to the one electrode of the second transistor and the gate electrode of the first transistor.

2. The display device according to claim 1, wherein a semiconductor layer of the first transistor comprises single crystal silicon.

3. The display device according to claim 1, wherein the second transistor and the capacitor are provided to overlap the first transistor.

4. An electronic device comprising the display device according to claim 1.

5. A display device comprising:
a driver circuit comprising a memory circuit,
wherein:
the memory circuit is configured to store a lookup table for correcting an image signal,
the memory circuit comprises a memory element including a first transistor, a second transistor, and a capacitor,
the first transistor includes a first semiconductor layer, a first gate insulating layer provided over the first semiconductor layer, and a first gate electrode provided over the first gate insulating layer,
the second transistor includes a second semiconductor layer, a first electrode in contact with the second semiconductor layer, a second electrode in contact with the second semiconductor layer, a second gate insulating layer provided over the second semiconductor layer, and a second gate electrode provided over the second gate insulating layer,
the capacitor includes the first electrode of the second transistor, the second gate insulating layer, and a capacitor electrode provided over the second gate insulating layer,
the second semiconductor layer comprises an oxide semiconductor, and
the first gate electrode and the first electrode of the second transistor are directly connected to each other.

6. The display device according to claim 5, wherein the first semiconductor layer comprises single crystal silicon.

7. An electronic device comprising the display device according to claim 5.

8. A display device comprising:
a driver circuit comprising a sensor circuit, a display control circuit, a memory circuit, a memory control circuit, and an image signal output circuit,
wherein:
the sensor circuit is configured to detect a change in external environment,
the display control circuit is configured to generate a lookup table for correcting an image signal based on a signal from the sensor circuit,
the memory circuit comprises a memory element including a first transistor, a second transistor, and a capacitor,
the memory circuit is configured to store the lookup table generated in the display control circuit,
the memory control circuit is configured to write the lookup table into the memory circuit,
the image signal output circuit is configured to output, to a display panel, the image signal corrected in accordance with the lookup table,
a gate electrode of the first transistor is connected to one electrode of the second transistor,
a semiconductor layer of the second transistor comprises an oxide semiconductor, and
the capacitor comprises the one electrode of the second transistor and a capacitor electrode provided over the one electrode of the second transistor.

9. The display device according to claim 8, wherein the sensor circuit is a photosensor circuit, a temperature sensor circuit, an angle sensor circuit, and/or a timer circuit.

10. The display device according to claim 8, wherein a semiconductor layer of the first transistor comprises single crystal silicon.

11. An electronic device comprising the display device according to claim 8.

12. A display device comprising:
a driver circuit comprising a sensor circuit, a display control circuit, a memory circuit, a memory control circuit and an image signal output circuit,
wherein:
the sensor circuit is configured to detect a change in external environment,
the display control circuit is configured to generate a lookup table for correcting an image signal based on a signal from the sensor circuit,
the memory circuit comprises a memory element including a first transistor, a second transistor, and a capacitor,
the memory circuit is configured to store the lookup table generated in the display control circuit,
the memory control circuit is configured to write the lookup table into the memory circuit,
the image signal output circuit is configured to output, to a display panel, the image signal corrected in accordance with the lookup table,
the first transistor includes a first semiconductor layer, a first gate insulating layer provided over the first semiconductor layer, and a first gate electrode provided over the first gate insulating layer,
the second transistor includes a second semiconductor layer, a first electrode in contact with the second semiconductor layer, a second electrode in contact with the second semiconductor layer, a second gate insulating layer provided over the second semiconductor layer, and a second gate electrode provided over the second gate insulating layer,
the capacitor includes the first electrode of the second transistor, the second gate insulating layer, and a capacitor electrode provided over the second gate insulating layer,
the second semiconductor layer comprises an oxide semiconductor, and
the first gate electrode and the first electrode of the second transistor are directly connected to each other.

13. The display device according to claim 12, wherein the sensor circuit is a photosensor circuit, a temperature sensor circuit, an angle sensor circuit, and/or a timer circuit.

14. The display device according to claim 12, wherein the first semiconductor layer comprises single crystal silicon.

15. An electronic device comprising the display device according to claim 12.
